(19) United States
(12) Patent Application Publication
(10) Pub. No.: US 2011/0225105 A1
(43) Pub. Date: Sep. 15, 2011

(54) METHOD AND SYSTEM FOR MONITORING AN ENERGY STORAGE SYSTEM FOR A VEHICLE FOR TRIP PLANNING

(75) Inventors: Richard Allen Scholer, Farmington Hills, MI (US); Douglas A. Oliver, Redford, MI (US); Derek Hartl, Royal Oak, MI (US); Dale Gilman, Beverly Hills, MI (US); Perry Robinson MacNeille, Lathrup Village, MI (US)

(73) Assignee: FORD GLOBAL TECHNOLOGIES, LLC, Dearborn, MI (US)

(21) Appl. No.: 12/909,111

(22) Filed: Oct. 21, 2010

(51) Int. Cl. G06F 7/00; H02J 7/00; G06F 17/00

(52) U.S. Cl. 705/412; 320/109; 701/33; 180/65.29

(57) ABSTRACT

One or more embodiments may include a trip planning system for planning a trip based on the charge of an electric vehicle battery. The trip planning system may include one or more computers located remotely from an electric vehicle which may have one or more battery packs for powering the electric vehicle. The computer(s) may be configured to receive geographic parameters defining a trip and a battery charge status of the one or more electric vehicle battery packs. The computer(s) may be further configured to determine that the trip cannot be completed based on the battery charge status. The computer(s) may additionally be configured to present a battery charge requirement for completing the trip.

### BACKGROUND

1. Technical Field

Various embodiments relate to monitoring an energy storage system for a vehicle. In some embodiments, the charge of an electric battery for a plug-in electric vehicle is monitored. In some embodiments, the monitoring may be used in monitoring the energy usage of a home, office, or other remote location where the electric vehicle is plugged. In additional or alternative embodiments, the monitoring may be used in trip planning.

2. Background Art

Various examples exist in the art that illustrate systems and methods for monitoring a battery charge of an electric vehicle.

As an example, U.S. Publication No. 2010/0094496 to Hershkovitz et al. discloses a system and method for operating an electric vehicle. According to the reference, a charge level of a battery of the electric vehicle is received. A current location of the electric vehicle is received. A theoretical maximum range of the electric vehicle is determined based on the current location of the electric vehicle and the charge level of the at least one battery of the electric vehicle. An energy plan for the electric vehicle is generated.

As another example, U.S. Publication No. 2010/0169008 to Niwa et al. discloses a navigation device presenting information regarding charging and a vehicle including the device. An ECU executes a program including detecting a present location using a GPS system. Data of a geographical map proximate to the present location is read out and, in the geographical map, charging installations including a charging installation employing solar light, together with the location of its vehicle is presented. Further, if a presentation switching request is made and a real-time solar radiation correction request is made, a solar radiation amount is detected. Further, a charge amount per unit time provided by the power generation installation employing solar light, based on the detected solar radiation amount is corrected. Further, an SOC in the battery to calculate an amount of discharge done until arrival at the charging installation is detected and time required for charging up to a fully charged state is calculated. Finally, the time required for charging is presented in the geographical map.

### SUMMARY

In one non-limiting aspect, a trip planning system for planning a trip based on the charge of an electric vehicle battery includes one or more computers which are remote from an electric vehicle. The electric vehicle may have one or more battery packs for powering the electric vehicle. The computer(s) may be configured to receive geographic parameters defining a trip and battery charge status of the electric vehicle battery packs. The battery charge status may be received (e.g., and without limitation, via the Internet) from an electric vehicle charging device which, in some embodiments, may be an appliance on a network of electric appliances at a remote location.

The computer(s) may be further configured to determine that the trip cannot be completed based on the battery charge status. Further, the computer(s) may be configured to present a battery charge requirement for completing the trip.

The battery charge requirement may include a time for charging the battery, a cost for charging the battery, or a number of needed battery charges. In some embodiments, the battery charge requirement may include a combination of these charging requirements.

In some embodiments, the computer(s) may be further configured to receive energy usage information from the network of electric appliances. The energy usage information may be factored into the battery charge requirement.

In a second non-limiting aspect, a method for planning a trip based on the charge of an electric vehicle battery includes monitoring at one or more computers for a connection with a charging device that charges one or more battery packs of an electric vehicle. The one or more computers may be in a location remote from the electric vehicle. The connection to the charging device may be established when detected.

The method may further include establishing at the one or more computers a data connection for receiving trip data in response to an input of one or more geographic parameters defining a trip. Additionally, the method may include receiving the trip data via the data connection and a battery charge status of the one or more electric vehicle battery packs via the charging device connection.

Based on the battery charge and the trip data, the method may further include determining that the trip cannot be completed. A battery charge requirement for completing the trip may be presented.

In some embodiments, the method may also include receiving monetary parameters defining a cost for the trip. Accordingly, determining that the trip cannot be completed may additionally be based on the received cost.

In a third non-limiting aspect, a method may include receiving geographic parameters defining a trip and a battery charge status of a battery pack in an electric vehicle. Additionally, the method may include determining that the trip cannot be completed based on the battery charge status. Further, the method may include presenting a time for charging the battery, a cost for charging the battery, and/or a number of needed battery charges to complete the trip.

In some embodiments, the method may include receiving trip influencing factors. Trip influencing factors may include, but are not limited to, weather and/or traffic. The method may also include factoring in the trip influencing factors for determining a time for charging the battery, a cost for charging the battery, and/or a number of needed battery charges.

These and other aspects will be better understood in view of the attached drawings and following detailed description of the invention.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 illustrates a block architecture for a system that may be used for trip planning and preparation based on the amount of charge in an electric vehicle;

FIG. 2 is a block topology of a vehicle computing system;

FIG. 3 is a process for trip planning and preparation based on electric vehicle charge according to one embodiment; and

FIG. 4 is a process for trip planning and preparation based on electric vehicle charge according to another embodiment.

### DETAILED DESCRIPTION

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

As will be described in one or more embodiments below, a remote system may determine for one or more users the amount of battery charge that may be required for an electric vehicle in order to travel to a particular destination. The remote system may additionally or alternatively determine the amount of charge available in an electric vehicle based on a designated cost of charging. In some embodiments, the remote system may determine a distance that can be traveled by a user to a particular location based on the designated battery charging cost. While the various embodiments are described with respect to the use of a battery energy source for the vehicle, other energy storage devices and systems (e.g., and without limitation, fuel, flywheels, supercapacitors, and other like rechargeable energy storage systems) may alternatively or additionally be used without departing from the scope of the invention.

The remote system may be at a home, office, school, library, or other like remote location. Typically, the remote location may be a location where charging of an electric vehicle may be possible. Further, the remote location may additionally be connected to a network, such as the Internet, a local area network (LAN), wide area network (WAN), and the like.

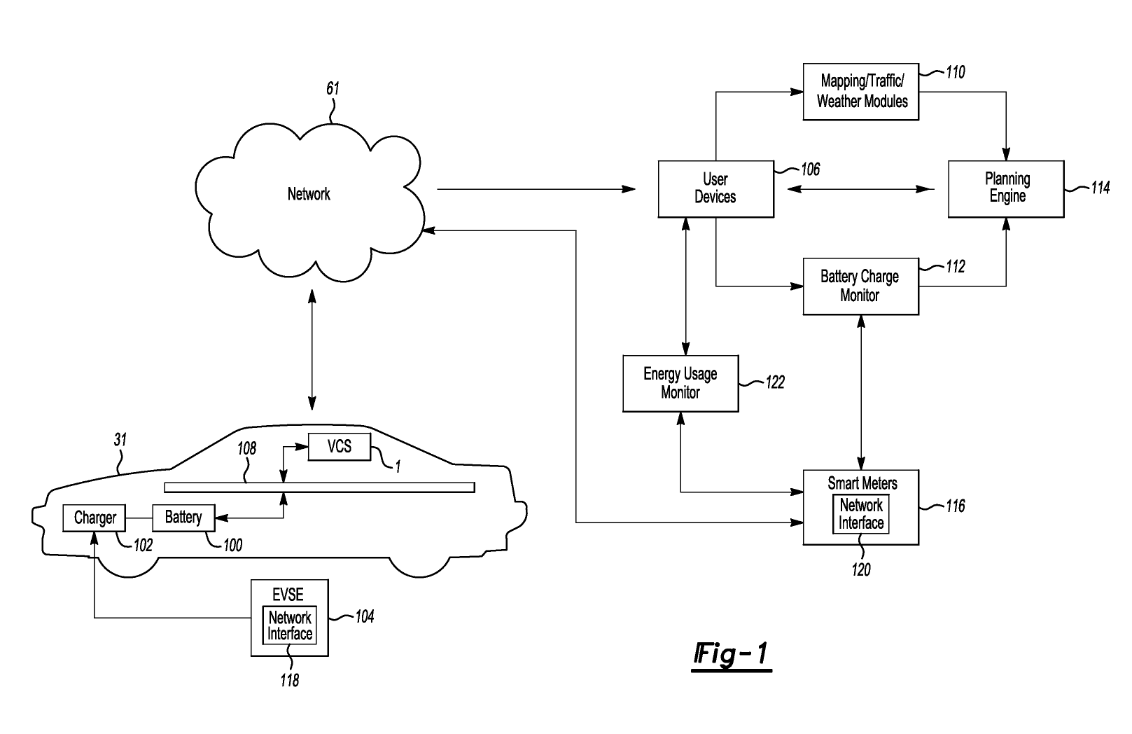

FIG. 1 illustrates a block architecture of a system that may be used for trip planning and preparation for travelling via an electric vehicle. The arrangement and configuration of FIG. 1 may be modified without departing from the scope of the invention such that the various components may be on board the vehicle or both on board and off board the vehicle.

A plug-in electric vehicle (PEV) 31 may be outfitted with one or more electric battery packs 100 for providing power to the PEV vehicle 31. The battery pack(s) 100 may include one or more chargers for capacitive or inductive charging of the battery pack(s) 100. In some embodiments, the battery pack(s) 100 may not include the charger 102.

Electric vehicle (EV) supply equipment (EVSE) 104 may be used to charge the vehicle 31. Charging may be accomplished using the EV supply equipment 104 by plugging in to the battery pack(s) 100 according to methods known in the art. The EV supply equipment 104 may include a transceiver (e.g., a network interface) 118 for receiving and transmitting data exchanged with the user terminal(s) 106. Further details of this data exchange will be described below.

A user may plan one or more trips from one or more user devices 106 at a remote location including, but not limited to, a home, an office, a library, a school, and other like remote locations. The user devices 106 may be one or more personal computers or one or more nomadic devices (including, but not limited to, mobile phones, PDAs, personal media players, and the like). The user device 106 may be configured with one or more network interfaces (not shown) for network communication 61 with the vehicle infotainment computer (VCS) 1. These network interfaces may include, but are not limited to, WiFi, WiMax, dial-up, Ethernet, DSL, ZigBee and the like. In some embodiments, the network communication interface may be powerline carrier communication (PLC) or broadband over power line (BPL). Other like network communication interfaces may be used without departing from the scope of the invention. Further, the user device 106 may be configured with a graphical interface for interacting with the system. In some embodiments, the interaction may occur using one or more audible commands. In alternative or additional embodiments, the interaction may occur using tactile commands.

Accordingly, the user devices 106 may exchange data with the vehicle 31 over a communication network 61. In some embodiments, the communication network 61 may be used using wireless communication with the vehicle 61. Network 61 may be the Internet, a local area network (LAN), a wide area network (WAN), or other like network communication.

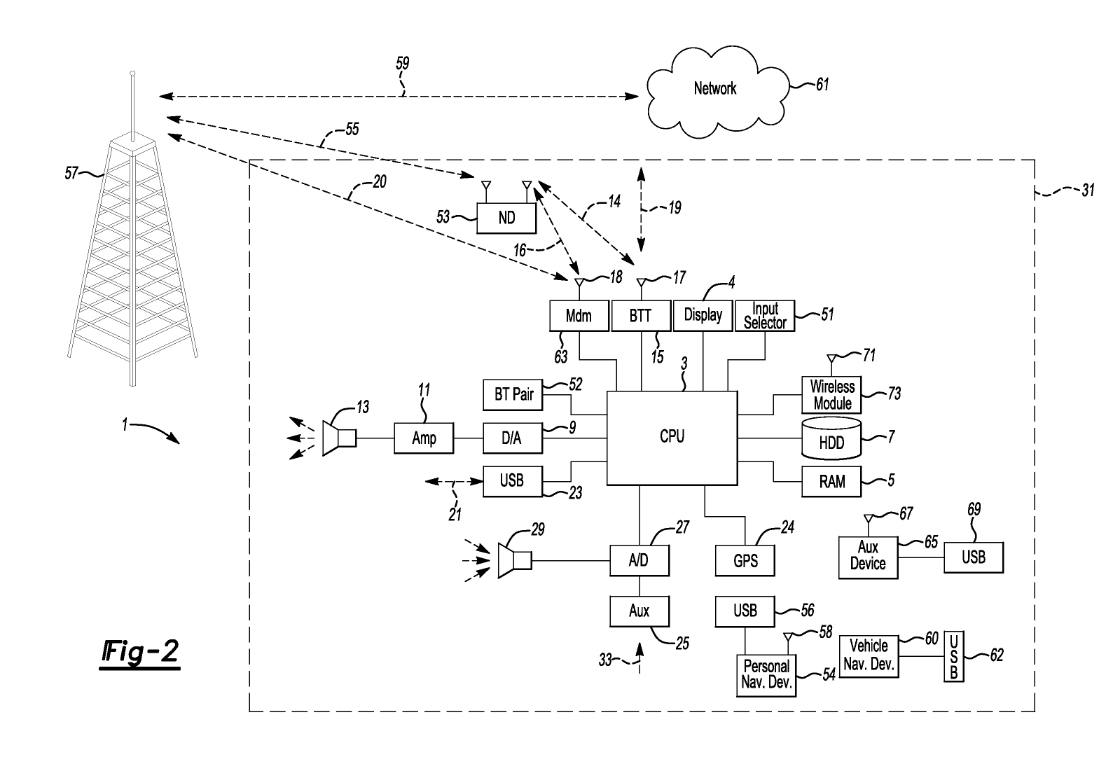

The vehicle 31 may be outfitted with an on-board communication unit for data exchange with the user device 106. The on-board communication unit may include a nomadic device (e.g., without limitation, a cellular phone) which may be used to transmit and receive communications through a cellular network (not shown). These communications may be relayed through network 61. In some embodiments, the on-board communication unit 1 may additionally or alternatively include a modem (not shown) for communication over network 61. As shown in FIG. 1, in some non-limiting embodiments, the on-board communications unit may be a vehicle infotainment computer (VCS) 1. An example of such a VCS 1 is the SYNC system manufactured by THE FORD MOTOR COMPANY. Further details of the VCS 1 will be described below with respect to FIG. 2.

The on-board communications unit (OCU) 1 may be in communication with a vehicle network 108 that communicates data to various vehicle control modules. Non-limiting examples of a vehicle network 108 include an SAE J1850 bus, a CAN bus, a GMLAN bus, and any other vehicle data buses known in the art. As shown in FIG. 1, the one or more battery packs 100 may be connected to the vehicle network 108. Other vehicle modules not shown (e.g., powertrain control modules, airbag control modules, and the like) may also be connected to the network 108. The battery charge data that may be exchanged with the user device(s) 106 may be received by the OCU 1 from the battery 100 via the vehicle network 108.

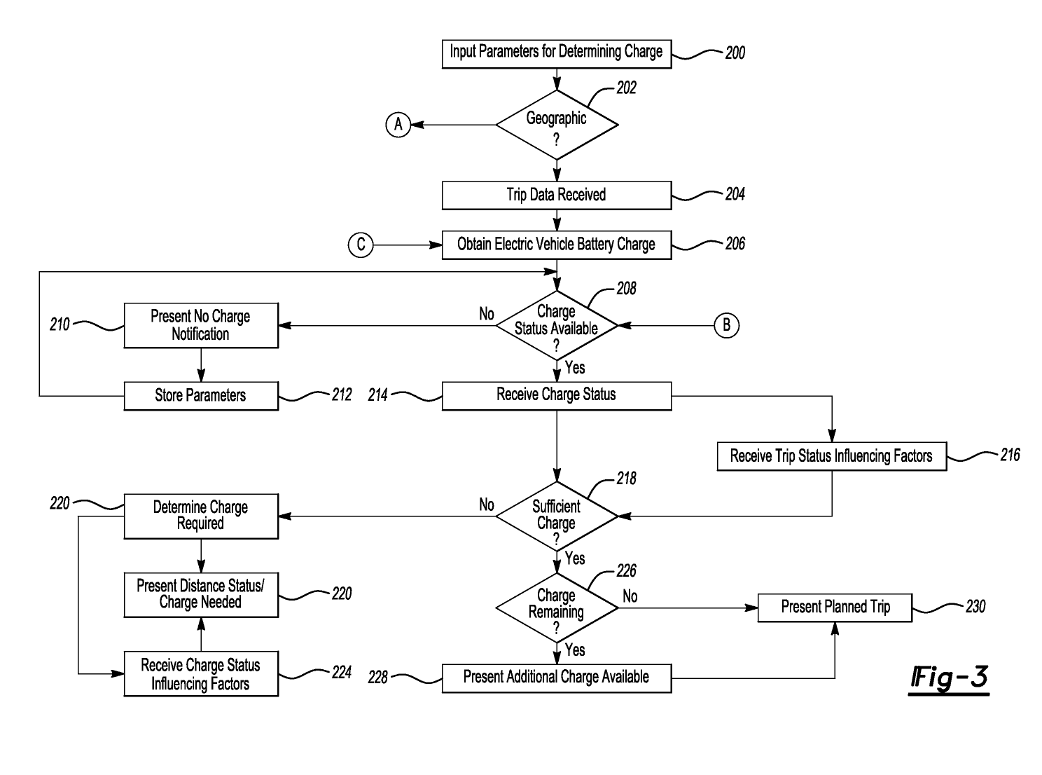

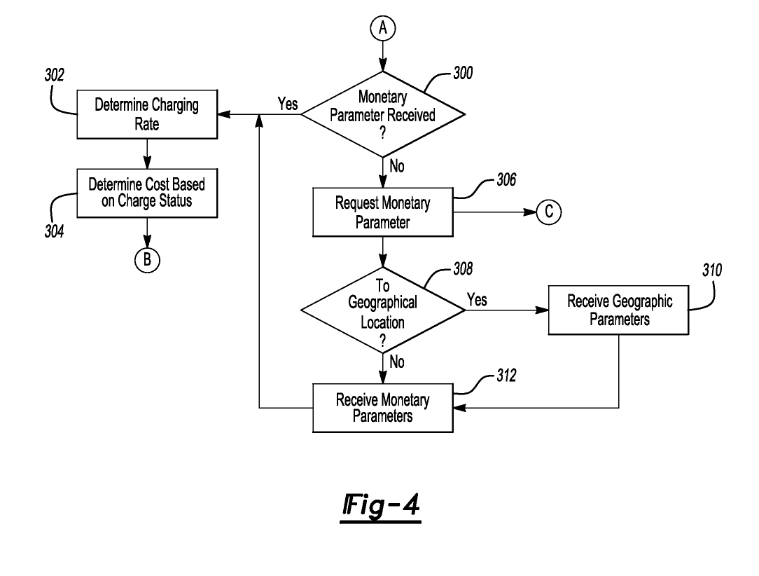

Referring back to the user devices 106, the device 106 may be configured with one or more modules used in monitoring and determining the battery charge of the EV 31. Each of these modules may be implemented on the user device(s) 106 as software. In some embodiments, the modules may be implemented on a server (not shown). In some embodiments, the server may be a third-party server. In this embodiment, the user device 106 may or may not include an application programming interface (API) for interfacing with the modules. While the operation of these modules will be described in further detail with respect to FIGS. 3 and 4, these modules will be introduced below.

One or more modules 110 may provide mapping/navigation information, traffic information, and/or weather information. This information may or may not be obtained from a third-party resource (e.g., a mapping service, traffic service and/or a weather service).

A battery charge monitor 112 may receive and monitor the battery charge status. The charge monitor 112 may communicate (via the user device 106) with one or more smart meters 116 from which battery charge information may be obtained. A smart meter 116 may be a device implemented by a utility company that can measure energy consumption by a commercial or residential establishment over a communications network. The smart meters 116 may obtain the charge status from the EV supply equipment 104 by exchanging commands and/or data with the supply equipment 104. Accordingly, the smart meters 116 may include a network interface 120 for communicating with the EVSE 104. In some embodiments, sub-meters (not shown) may additionally be used for energy usage monitoring.

The charge status information may additionally or alternatively be received from the battery 102 via the OCU 1. In this non-limiting embodiment, the OCU 1 may be programmed with logic for translating the battery charge information received via the vehicle network 108 to information capable of being processed and interpreted by the battery charge monitor 112. For example, and without limitation, a look up table stored on the OCU 1 may be used for performing this conversion. Alternatively or additionally, at least part of the conversion/translation may be performed on the user device 106 (e.g., and without limitation, by the battery charge monitor 112).

In some embodiments, an energy usage monitor 122 may monitor and report the energy usage of one or more appliances within the remote location (e.g., a home or office), including the EVSE 104. The energy usage monitor 122 may obtain usage information from the smart meter 116, the appliances (not shown), or both. These one or more appliances may be connected on a local area network (LAN). In some embodiments, the LAN may be a home area network (HAN).

The energy usage by some or all appliances within the remote location may be factored into the charge status of the battery. In one embodiment, as will be described in further detail below, the charge status of the battery may be used in determining how long of a charge is required in order to travel a particular distance in the vehicle 31. Accordingly, a user may unplug some appliances if a faster charge is desired by the user. In some embodiments, a user may additionally or alternatively defer usage of some devices. The deferment may or may not be automatically programmed from the user device 106. As a non-limiting example, the user may schedule usage of other appliances based on the battery charge time.

The trip planning engine module 114 may determine/calculate the distance the vehicle 31 can travel on a charge of the battery 100. As a non-limiting example, the module 114 can determine whether the user can arrive at a destination (input via the mapping/traffic/weather module 110) based on the amount of battery charge. In some embodiments, the determination module 114 may calculate a minimum charge level needed for the travel. As non-limiting examples, the module 114 may determine that a “½ charge” is needed for the travel or that “1½ charges” are needed (e.g., 1 full charge and a half charge) for the travel. Of course, these values are merely exemplary and provided for illustration.

The module 114 may additionally or alternatively determine an amount of time it may take to charge the battery 100 in order to reach the destination. Referring to the above non-limiting example, if there is not enough charge to reach the destination, the module 114 may determine that if the battery 100 is charged for “X minutes,” the user may reach the destination. In some embodiments, the time may be based on completing a round-trip travel. In some embodiments, the time determination may be a minimum time for charging. In additional embodiments, the user may be given the time needed to charge the battery to reach a charging station along the travel route in order to reach the destination.

The module 114 may be programmed with one or more algorithms for making its time-based determination(s). For example, the algorithm may use the amount of charge needed to travel a particular distance (e.g., X watt-hours of battery charge permits one mile or one KM of travel), the amount of time to charge the battery per mile/km of travel, and the total distance of the trip (e.g., in miles or kilometers) to determine the time-based charge information. Additionally or alternatively, the module 114 may use a historical average consumption by the user in making the determination. These examples are provided for illustration purposes. Accordingly, other algorithms may be used without departing from the scope of the invention.

In some embodiments, the distance determination may be based on a monetary value of the charge. For example, the user may inquire how far the vehicle can travel on a $5 charge of the battery. As another example, the user may inquire how long the $5 charge may take to complete. In this case, the smart meters 116 may provide rate information for the battery charge. This rate information may be set by one or more utility companies. Alternatively, the monitor 112 may be programmed with the rate information (obtained from one or more utility companies). In this case, when changes to the rate occur, software updates may be performed manually (e.g., by the OEM) and/or automatically.

Accordingly, the module 114 may additionally or alternatively determine a distance that may be travelled for a defined battery charge cost. As a non-limiting example, the module 114 may determine the distance that may be travelled for “$X” of charging. While the example illustrates the use of dollars as a monetary unit, certainly other monetary units may be utilized without departing from the scope of the invention. As another non-limiting example, the module 114 may determine how much a trip will cost with respect to the amount of battery charging needed for the trip. That is, a determination may be made as to how much charging may be needed (e.g., in a monetary value) to reach a particular destination and/or complete a round trip. In some embodiments, the monetary amount may be a minimum monetary amount.

In some embodiments, the planning module 114 may provide two or more battery charge requirements (e.g., and without limitation, time-based information and monetary information). In further embodiments, the user may customize the presentation of the information (e.g., and without limitation, time-based and/or monetary). While the various embodiments are described as providing charge information based on a time lapse and/or cost of the charge, the information may be based on additional values without departing from the scope of the invention.

The algorithms implemented on the module 114 may factor conditions such as (and without limitation) traffic, road conditions (e.g., and without limitation, uphill/downhill, dirt, etc.), road type (e.g., city or highway), and weather in order to provide the determination. Other non-limiting factors may include environment friendly travel and lowering carbon cost (e.g., carbon footprint). For example, and without limitation, the determination may include adding additional charge value to the battery to account for inclement weather (which may cause the vehicle to use more battery power). Thus, a certain percentage (or other value) may be added to the amount of charge normally required to account for the inclement weather. The same may be true for traffic conditions along the route.

FIG. 2 illustrates an example block topology for a vehicle based computing system 1 (VCS) for the vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 2, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73. Auxiliary device 65 may include, but are not limited to, personal media players, wireless health devices, portable computers, and the like.

FIG. 3 illustrates a process for planning a trip based on the battery charge of the electric vehicle 31. It will be appreciated that the disclosure and arrangement of FIG. 3 may be modified or re-arranged to best fit a particular implementation of the various embodiments of the invention.

The parameters for determining the charge status needed for a trip may be input from one or more of the user devices 106 (block 200). The parameters may be geographic parameters, monetary parameters, or other parameters as described above. In the non-limiting example illustrated in FIG. 3, it may be determined that the parameters are geographic parameters (block 202) based on the receipt of the geographic parameters by the module 114. Circle block A (illustrated in FIG. 4) represents the scenario where the monetary parameters are additionally or alternatively received. FIG. 4 will be described in further detail below. In some embodiments, a user may select the type of parameters desired to be input (e.g., monetary and/or geographic) before the parameters are input.

The geographic parameters may be input to and received from the mapping/traffic/weather module 110. These parameters may include, but are not limited to, a departing location, an arrival location, a point of interest, a zip code, and other like parameters. In some embodiments, multiple parameters may be input. As a non-limiting example, a departure location and a point of interest may be input. Trip data may be generated (e.g., and without limitation, directions and trip distance) and received by the module 114 (block 204). In some embodiments, the trip data may also include traffic information and weather information.

The battery charge status of the vehicle battery 100 may be obtained based on the information from the battery charge monitor 112 (block 206).

In some instances, a charge status may not be obtainable or available. As some non-limiting examples, the user devices 106 may not be within range of connecting to the vehicle 31 via network 61, a network connection cannot be generated, the EVSE 118 is not plugged into the vehicle 31, and other like connectivity issues. If no charge status is available (block 208), a connection failure notification may be presented to the user at device(s) 106 (block 210). In some embodiments, the notification may include one or more specific reasons for the failure to determine a charge status.

In some embodiments, the parameters that may be input from the device(s) 106 (block 200) may be stored at the device(s) 106 until the charge status can be determined (block 212) (e.g., a connection to the vehicle 31 and/or the EVSE 118 can be established). When the charge status can be determined, the stored parameters may be automatically input to the module 114. Alternatively or additionally, the user may be notified of the stored parameters. The user may input the stored parameters if desired (e.g., and without limitation, in response to the notification asking if the user wishes to input the stored parameters).

The charge status may be received (block 214), if the charge status is available/obtainable (block 208). The charge status may indicate whether the battery 100 has a full or partial charge. The status may be presented as text, numbers, a graphic, or a combination of these. Other status identifier may be used without departing from the scope of the invention.

In some embodiments, factors that may influence/affect the distance that the vehicle 31 may travel on the vehicle charge may be received (block 216). These factors may include, but are not limited to, weather and traffic. Other non-limiting factors are described above.

A determination may be made by module 114 whether there is sufficient charge in the battery 100 to complete the trip entered by the user (block 218). This determination may or may not account for the trip influencing factors described above. Alternatively or additionally, the determination may include whether the trip may be completed on the cost of charging entered by the user and/or how far the user may travel on the cost of charging desired.

The user may be notified that the battery needs additional charging in order to complete the trip if there is not sufficient charge in the battery. The amount of charge needed to complete the trip may be determined (block 220) and presented to the user (block 222). The status information may or may not be presented during battery charging.

In some embodiments, the user may be presented with the amount of time needed to charge the battery 100. For example, and without limitation, the user may be notified that the battery needs an additional “X minutes” of charging. Various units of time measurement (e.g., seconds, minutes, hours, etc.) can be used without departing from the scope of the invention. In some embodiments, the number of battery charges that are needed for completing the trip may be presented. This may or may not include the battery charges needed to reach a charging station. In further embodiments, the cost of charging the battery for completing the trip may be presented. In further embodiments, a combination of two or more of the charging time, number of charges, and cost of charging may be presented.

In some embodiments, charge status influencing factors may be received (block 224). The charge status influencing factors may be the energy usage from the other appliances connected to the remote location. In this case, the charge status of the battery may be affected based on the amount of energy used by, and the number of, appliances. Thus, as a non-limiting example, if there are multiple appliances connected that consume a significant amount of energy, the charging time needed for the battery 100 may be modified (e.g., increased) to account for the additional energy usage. If the user unplugs an appliance, the charge time may be further modified (e.g., decreased) to account for the “extra” energy available to charge the battery 100.

Where there is sufficient charge to complete the trip (block 218), a further determination may be made whether there would be any charge remaining in the battery once the trip is complete (block 226). In some embodiments, this information may be helpful to the user if, for example, an unanticipated trip (e.g., and without limitation, a detour) is made during the original trip.

The user may be presented with the available charge in the battery (e.g., if partial, the amount of charge), which may include the remaining charge that may be used once the trip is complete (block 228). In some embodiments, the user may be presented with the distance value that can be traveled with the remaining charge (e.g., in miles and/or kms).

The planned trip may be presented to the user at the user device(s) 106 (block 230). The planned trip may include the distance that can be travelled on the charge available on the battery 100. In some embodiments, the user may alternatively or additionally be presented with the cost of the trip based on the battery charge.

In some embodiments, the planned trip may be transmitted to the VCS 1 over a wireless or wired connection. The planned trip may be used by the navigation system 54, 60 to navigate the user along the route.

In some embodiments, the planning engine 114 may be programmed to receive trip settings (e.g., and without limitation, vehicle settings and music) from the user via the user device(s) 106. Thus, the user may configure vehicle settings from the user device(s) 106 and transmit these setting to the vehicle using a wired or wireless connection for the planned trip. For example, the user may set seat settings and HVAC settings to the vehicle 31. The user may additionally or alternatively download information (such as media) to the vehicle 31 for the planned trip. For example, the user may download music and/or videos from the device(s) 106 to the vehicle 31.

Referring now to FIG. 4, the process for trip planning using monetary parameters (continued from circle block A in FIG. 3) is illustrated. It will be appreciated that the disclosure and arrangement of FIG. 2 may be modified or re-arranged to best fit a particular implementation of the various embodiments of the invention.

If a monetary parameter is received (block 300), the rate for charging the battery may be determined (block 302). Using the rate information, the cost for charging the battery 100 based on the battery's charge status may be determined (block 304). The process may continue at circle block B.

A monetary parameter may be requested for from the user if no parameters have been received (block 306). The process may continue at circle block C.

In some embodiments, monetary parameters and geographic parameters may be used. A determination may be made if the parameters input by the user (block 200) include geographic parameters (block 308). If so, the geographic parameters may be received (block 310) and the process continue as illustrated in FIG. 3.

In some embodiments, the user may be presented with charging stations along the user's route that may provide cheaper charging rates than that available at the user's location. This information may be obtained from and/or stored in, for example, module 110. The user may be presented with the charging time needed to get to the charging station and/or the cost of charging the battery in order to reach the charging station as part of the planned route (block 230). In some embodiments, the user may be further presented with the cost of charging at the charging station (which may or may not include the cost associated with charging from the remote location). This may presented as a comparison with the cost for alternatively charging at the remote location.

Referring back to FIG. 3, the process may otherwise be performed based on the monetary parameters (block 312).

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

1. A trip planning system for planning a trip based on the charge of an electric vehicle battery, the trip planning system comprising:
one or more computers located remotely from an electric vehicle having one or more battery packs for powering the electric vehicle, the computer(s) being configured to:
receive geographic parameters defining a trip;
receive battery charge status of the one or more electric vehicle battery packs;
determine that the trip cannot be completed based on the battery charge status; and
present a battery charge requirement for completing the trip.

2. The trip planning system of claim 1 wherein the battery charge requirement is a time for charging the battery, a cost for charging the battery, a number of needed battery charges, or a combination of charging requirements.

3. The trip planning system of claim 1 wherein the battery charge requirement is a minimum requirement.

4. The trip planning system of claim 1 wherein the battery charge status is from an electric vehicle charging device which is on a network of electric appliances at the remote location.

5. (canceled)

6. The trip planning system of claim 4 wherein the one or more computers are further configured to:
receive energy usage information from the network of electric appliances; and
factor the energy usage information into the battery charge requirement.

7. The trip planning system of claim 1 wherein the computer(s) are configured to receive the battery charge status over a communication network.

8. (canceled)

9. The trip planning system of claim 1 wherein the one or more computers are located at a home, office, library, or school.

10. (canceled)

11. A method for planning a trip based on the charge of an electric vehicle battery, the method comprising:
monitoring at one or more computers for a connection with a charging device that charges one or more battery packs of an electric vehicle, the one or more computers being in a location remote from the electric vehicle;
establishing the charging device connection when detected;
establishing at the one or more computers a data connection for receiving trip data in response to an input of one or more geographic parameters defining a trip;
receiving the trip data via the data connection;
receiving at the one or more computers a battery charge status of the one or more electric vehicle battery packs via the charging device connection;
determining that the trip cannot be completed based on the battery charge and the trip data; and
presenting a battery charge requirement for completing the trip.

12. The method of claim 11 wherein the battery charge requirement is a time for charging the battery and a cost for charging the battery.

13. The method of claim 11 further comprising:
receiving monetary parameters defining a cost for the trip; and
determining that the trip cannot be completed additionally based on the received cost.

14. The method of claim 11 wherein presenting the battery charge requirement includes presenting the battery charge requirement on a display in the remote location.

15. The method of claim 11 further comprising storing the geographic parameters on the one or more computers if the charging device connection is not detected.

16. A method for:
receiving geographic parameters defining a trip;
receiving a battery charge status of a battery pack in an electric vehicle;
determining that the trip cannot be completed based on the battery charge status; and
presenting a time for charging the battery, a cost for charging the battery, and/or a number of needed battery charges to complete the trip.

17. The method of claim 16 further comprising:
determining if the battery charge status can be received; and
if the charge status cannot be received, storing the geographic parameters on a computer.

18. The method of claim 17 wherein the computer is an on-board vehicle communication unit.

19. The method of claim 16 further comprising:
receiving trip influencing factors; and
factoring in the trip influencing factors for determining a time for charging the battery, a cost for charging the battery, and/or a number of needed battery charges.

20. The method of claim 19 wherein the trip influencing factors includes weather, traffic, or both.

21. The method of claim 16, wherein the method is performed on one or more computers in a first location, the method further comprising:
comparing a cost of charging at a second location, the second location being a battery charging station, with a cost of charging at the first location;
if the battery charging station is a lower cost of charging than the cost of charging at the first location, presenting the cost of charging in order to reach the battery charging station; and
presenting the cost for charging in order to complete the trip, including the cost of charging at the battery charging station.

22. (canceled)

23. The method of claim 16 further comprising receiving trip settings selected from the group consisting of media and vehicle settings.

24. The method of claim 23 further comprising:
configuring the trip settings from a location remote from the electric vehicle; and
transmitting the settings to an on-board communications unit in the electric vehicle.
